(19) United States
(12) Patent Application Publication
(10) Pub. No.: US 2010/0299386 A1
(43) Pub. Date: Nov. 25, 2010

(54) COMPUTER-BASED SYSTEM COMPRISING SEVERAL NODES IN A NETWORK

(75) Inventors: Nabil Ben Khalifa, Toulouse (FR); Olivier Cozette, Toulouse (FR); Christophe Guittenit, Toulouse (FR); Samuel Richard, Toulouse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Seanodes, Colomiers (FR)

(21) Appl. No.: 12/445,581

(22) PCT Filed: Oct. 25, 2007
(86) PCT No.: PCT/FR07/01765

§ 371 Date: Apr. 15, 2009

(30) Foreign Application Priority Data
Oct. 26, 2006 (FR) 0609406
Oct. 24, 2007 (FR) 0707476

(51) Int. Cl. G06F 15/16

(52) U.S. Cl. 709/203

(57) ABSTRACT

A computer-based system includes plural computer-based facilities termed nodes interconnected in a network, including storing nodes that include a direct-access local memory unit, and a storage server for managing access to this unit based on a queue, application nodes, each including: an application environment with a representation of files that are accessible in a form of addresses of blocks designating a physical address on a local memory unit, and a storage client capable of interacting with a storage server, based on an access request designating a block address. The storage server includes a scheduler capable of executing the access requests contained in its queue in a determined order. The order is determined as a function of a set of rules forming performance criteria, and involving one or more state parameters of the queue and/or of the storing node on which it resides.

The invention relates to computer-based systems comprising several computer facilities or stations known as nodes interconnected in a network.

Modern networks comprise user stations which are connected to one or more servers and can share applications and/or storage spaces either locally or remotely.

Within the scope of shared applications making use of a substantial quantity of data or within the scope of the sharing of a substantial quantity of data it is common to use specialised storage systems such as Storage Area Networks (or SAN).

The use of these improved systems has certain disadvantages such as the associated costs, performance and extensibility limitations and the general unwieldiness of the installation which corresponds to them.

Moreover, with modern networks, the use of these improved systems represents an under-utilisation of the equipment already present in the network.

The invention sets out to improve the situation.

To this end, the invention proposes a computer-based system comprising a plurality of computer-based facilities termed nodes interconnected in a network. At least some of the nodes, known as storing nodes, comprise at least one local direct-access memory unit, and a storage server arranged to manage access to this local memory unit on the basis of a queue of access requests.

At least some of the nodes, known as application nodes, each comprise:
an application environment provided with:
   a file system manager, arranged to maintain a representation of files which are accessible from this node in the form of virtual addresses, and
   a correspondence module, capable of maintaining a correspondence between each virtual address and at least one physical address on a local memory unit of a storing mode, and
a storage client capable of interacting with any one of the storage servers, on the basis of an access request designating a physical address.

In this computer-based system, at least one of the storage servers comprises a scheduler capable of executing the access requests contained in its queue in a specified order, and the scheduler is arranged to determine this order as a function of a set of rules forming performance criteria, and involving one or more state parameters of the queue and/or of the storing node on which it resides.

A computer-based system of this kind has the advantage of using the intrinsic storage resources of the stations (which will also be called nodes) of the network in order to store the data effectively. In these stations, the storage server may be used to optimise the use of the network and the storage resources. This system thus makes it possible to make maximum use of the intrinsic capacities of the network without the need for specialised systems.

The invention also relates to a process for data management which can be used in a network comprising a plurality of interconnected computer-based facilities, known as nodes, comprising the following steps:

a. sending a file request from an application node of the network, on the basis of a representation in the form of virtual addresses,

b. on the basis of a correspondence between each virtual address and at least one physical address on a local memory unit of a storing node of the network, determining at least one physical address corresponding to said virtual address,

c. sending an access request designating said physical address to a storage server managing access to its local memory unit, and

d. placing the access request in a queue in said storage server and executing the access requests contained in said queue, in an order which is determined as a function of a set of rules forming performance criteria, and involving one or more state parameters of the local memory unit or units and/or of the storing node in question (processor load, level of occupancy of the central memory, etc).

Further advantages and features of the invention will become apparent from a study of the description that follows of some embodiments provided as an illustration, without being restrictive, on the basis of the drawings wherein:

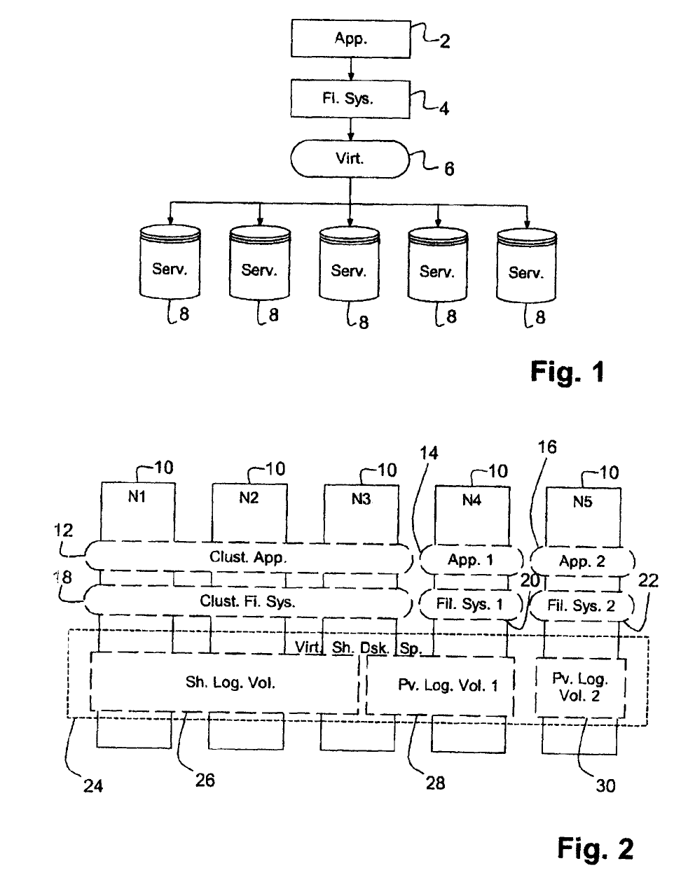

FIG. 1 shows a general functional view of a computer-based system according to the invention,

FIG. 2 shows an example of the logical implementation of the system in FIG. 1,

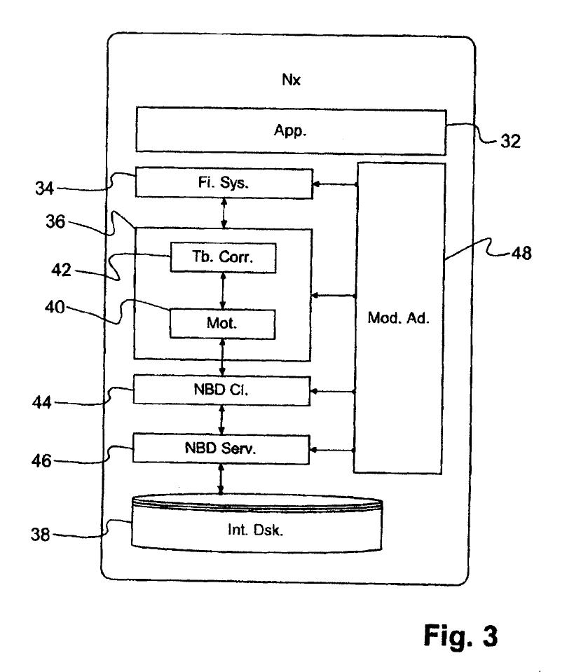

FIG. 3 shows an example of the composition of an element from FIG. 2,

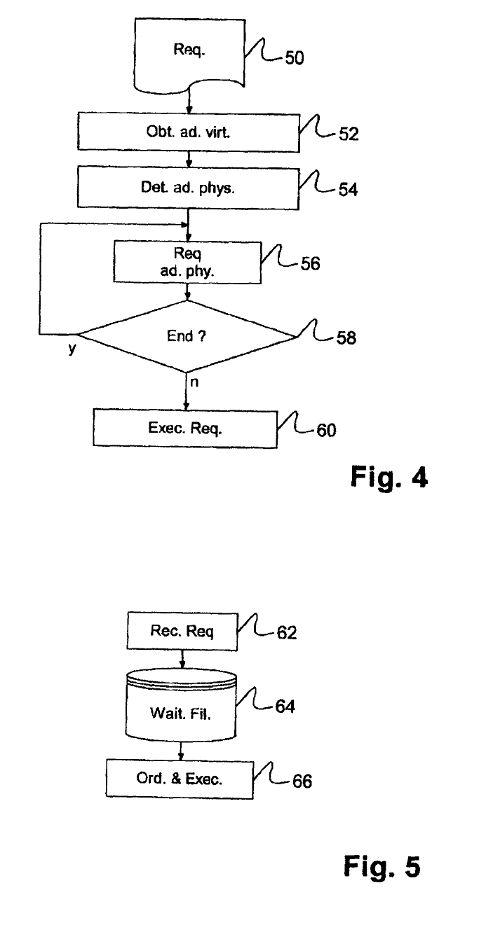

FIG. 4 shows a method of access to a file in the system in FIG. 1,

FIG. 5 shows an example of the functional implementation of part of the process in FIG. 4,

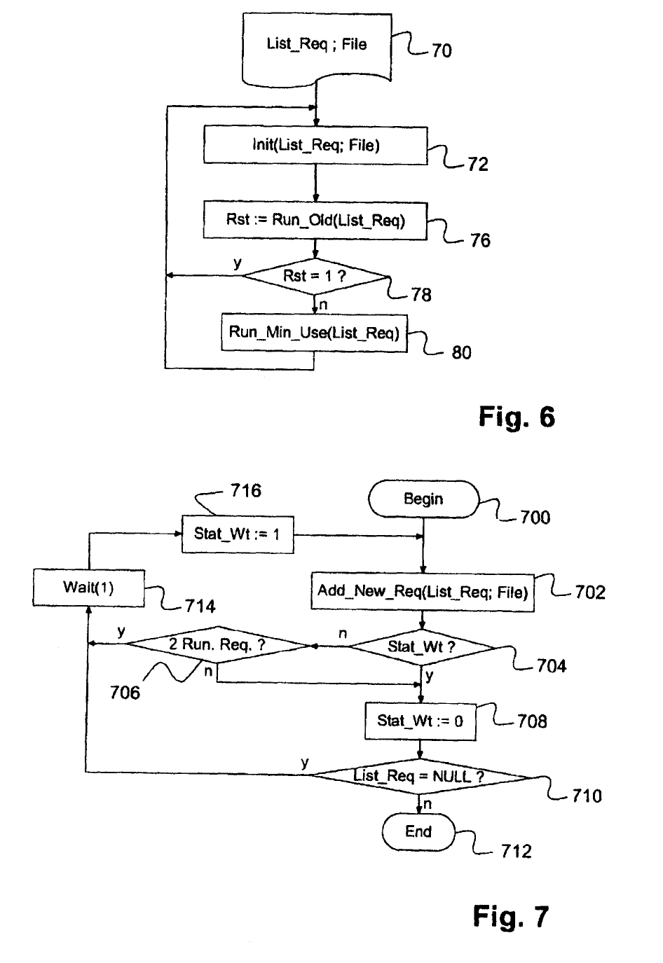

FIG. 6 shows an example of a scheduling and execution loop in a storage server within the scope of the implementation of FIG. 5,

FIGS. 7 to 10 show examples of functions in FIG. 6,

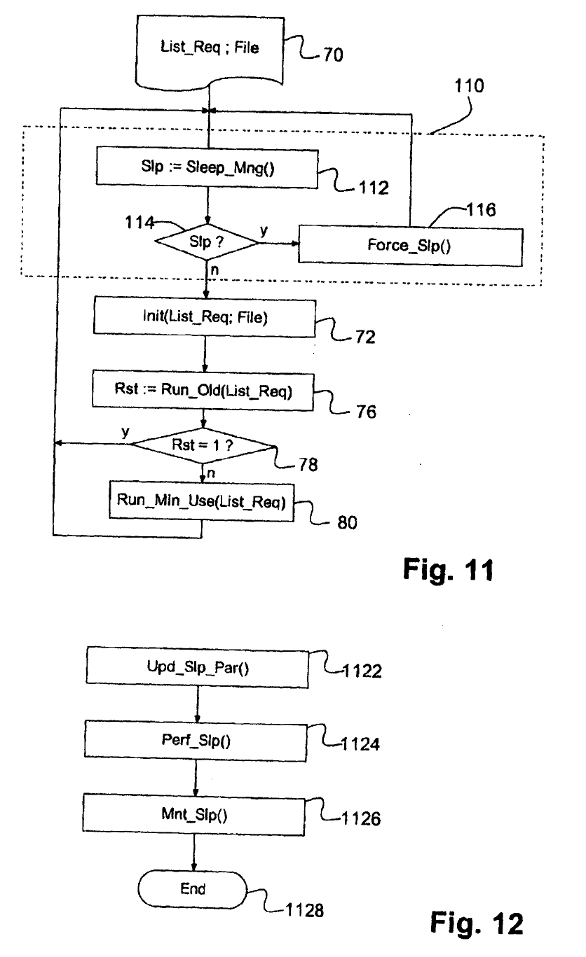

FIG. 11 shows an example of a scheduling and execution loop of a storage server in an alternative embodiment,

FIG. 12 shows an example of a function from FIG. 11, and

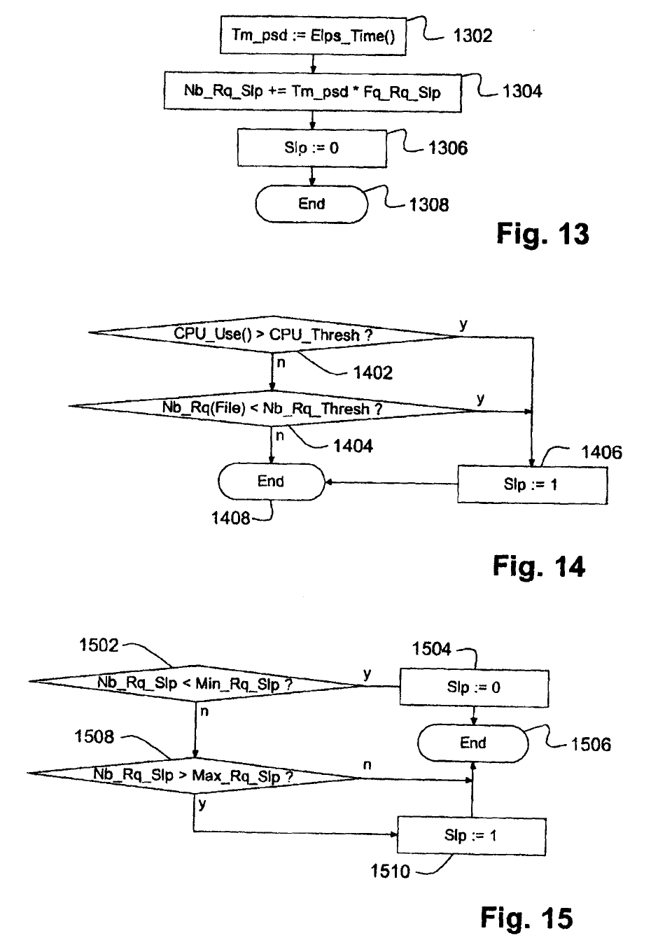

FIGS. 13 to 15 show examples of functions from FIG. 12.

The drawings and description that follow essentially contain elements of a certain nature. They may serve not only to assist the understanding of the present invention but help to define it, where appropriate.

The present invention is of a kind that makes use of elements eligible for copyright protection. The proprietor of the rights has no objection to identical reproduction by anyone of the present patent document or its description, such as it appears in the official files. For the remainder, the author reserves his rights in full.

FIG. 1 shows a general plan of a computer-based system according to the invention. In this system, an application environment 2 has access to a file system manager 4. A virtualisation layer 6 establishes the correspondence between the file system manager 4 and the storage servers 8.

FIG. 2 shows a logical implementation of the system in FIG. 1. In this implementation, a set of stations 10, also referred to here as nodes, are interconnected in a network of which they form the physical and application resources.

In the example described here, the network is made up of 5 stations labelled Ni where i varies between 1 and 5. The application environment 2 is made up of an application layer 12 distributed over N1, N2 and N3, an application layer 14 over N4 and an application layer 16 over N5.

It will be noted that the term facility or station used here should be interpreted generally as referring to computer-based elements of the network on which applications or server programs or both run. The file system manager 4 is made up of a distributed file system 18 and two non-distributed file systems 20 and 22. The system 18 is distributed over N1, N2 and N3 and defines all the files which can be accessed from the distributed application layer 12. The files systems 20 and 22 respectively define all the files which can be accessed from the application layers 14 and 16.

The files designated by the file systems 18, 20 and 22 are stored physically in a virtual storage space 24 which is distributed over all the Ni where i varies between 1 and 5. The virtual storage space 24 is divided here into a shared logic space 26 and two private logic spaces 28 and 30.

The shared logic space 26 corresponds to the space that can be accessed from the distributed application layer 12 by means of the distributed file system 18, and the private logic spaces 28 and 30 correspond to the space which can be accessed from the application layers 14 and 16 by means of the file systems 20 and 22.

The logic space 26 is distributed over N1, N2 and N3, the private logic space 28 over N3 and N4, and the private logic space 30 over N5.

Thus, an application of the layer 12 (or 14 or 16, respectively) “sees” the data stored in the logic space 26 (or 28 or 30, respectively) by means of the file system 18 (or 20 or 22, respectively) even though the data are not necessarily physically present on one of the storage disks of the station 10 that uses this application.

Moreover, the spaces 26, 28 and 30 are purely logical, i.e. they do not directly represent physical storage spaces. The logic spaces are mapped by means of virtual addresses which are referenced or contained in the file systems 18, 20 and 22.

In order to access the data in these files, it is necessary to use a correspondence module. The correspondence module contains a correspondence table between the virtual addresses of the data in the logic spaces and the physical addresses which denote the physical storage spaces in which these data are actually stored.

Numerous embodiments are possible for the correspondence module. The distribution of the physical storage spaces described here is an example intended to show the very general scope of the invention.

As can be seen from the example shown, each station is used both for the application layer and for the storage layer. This multifunctionality makes it possible to use the free space over all the stations of the network rather than leaving this space unoccupied.

Within the scope of the invention, however, it would be possible to specialise some of the stations and to create a node dedicated to storage or a node dedicated to applications.

This means that, within the scope of the invention, any station may act as an application node, a storing node or perform both roles at the same time.

All the application, storage and file system resources may be integrated locally at each station or distributed over the stations of the network.

This is the case for example with the stations N1, N2 and N3, the resources of which are integrally distributed both at the application level and at the file system and storage level.

FIG. 3 shows an example of the architecture of a station 10 in FIG. 2. The station shown in this example may represent one of the stations N1, N2 or N3.

The station Nx individually has a structure similar to that of the global structure shown in FIG. 1. It thus comprises an application layer 32, a file system 34, a virtualisation layer 36 and a storage space 38 in the form of a direct access local memory.

The virtualisation layer 36 comprises a motor 40 and a correspondence table 42. The direct access to the storage space 38 is managed by a storage client 44 and a storage server 46. The roles and methods of operation of these elements will be described hereinafter.

The example described here shows an improved embodiment of the invention in which all the resources, both application and storage, are distributed over the network.

This means for example that the file system 34 is not present in its entirety at this station but is distributed over several of them and that access thereto involves communication with other nodes of the network which contain the desired data.

The same is true of the virtualisation layer 36, the storage client 44 and the storage server 46. The distribution of these elements is managed by means of an administration module 48.

The administration module 48 is chiefly used when creating and updating the logic spaces. During the creation or modification of a logic space, the administration module 48 calls up the virtualisation layer 36 in order to create the correspondence table between each virtual address of the logic space and a physical address on a given storing node.

Then the correspondences between a file which can be accessed through this system of files and the virtual addresses of the data that make up the file are established at the level of the file system which exploits this logic space, the “physical” data being stored in the physical addresses associated in the correspondence table with the virtual addresses, in accordance with the mapping drawn up when the logic space is created.

This means that, as soon as a logic space has been created by the administration module, the correspondences between the virtual addresses and the physical addresses are produced. The virtual addresses thus appear to be “empty” in the file system giving access to the logic space, whereas the physical addresses which correspond to them are already “reserved” by means of the correspondence table.

It is when the link between the data in the file in this space and the virtual addresses of these data is established that the physical addresses are filled.

The work done by the virtualisation layer may be carried out in various ways. In one embodiment, the virtualisation layer distributes the data over the heterogeneous storage resources to find the best compromise between exploiting the flow of storage resources in the network and exploiting the storage capacity of these resources. An example of this virtualisation layer is described in paragraphs [0046] to [0062] of EP Patent 1 454 269 B1.

The virtualisation layer 36 may also incorporate a mechanism for safeguarding written data. This mechanism may for example be based on a selective duplication of each write request with physical addresses situated on physical storage spaces located at distinct stations, in the manner of a RAID.

The correspondence table 42 is not necessarily a simple table. It may in particular contain configuration data relating to the logic space or spaces for which it maintains the correspondences. In this case it may in particular interact with mechanisms of the virtualisation layer 36 which for updating the distribution of correspondences between virtual addresses and physical addresses, in order to ensure the best compromise between exploiting the flow of storage resources in the network, and exploiting the storage capacity of these resources. One embodiment of these mechanisms is described in paragraphs [0063] to [0075] of EP Patent 1 454 269 B1.

Throughout the remainder of the description it does not matter whether the resources under consideration are distributed or not.

To assist with the understanding of the invention it is advisable to differentiate the application layer from the storage layer. In fact, managing access to the data stored in the storage layer is an approach which has numerous advantages over the existing methods.

FIG. 4 shows a process carried out by the system for accessing a file.

Access to a file by application of the application layer of a given node is initiated by a file access request 50. The file access request 50 comprises:
an identifier of the file in question for the file system and an address in this file,
the size of the request, i.e. the number of bits to access following the address of the intended file, and
the type of request, namely read or write.

In a step 52, the file system determines one or more virtual addresses for the data in this file, and generates one or more virtual access requests on the basis of the request 50 and these virtual addresses.

The virtual access requests each comprise:
the desired virtual address,
the size of the request, i.e. the number of bits to access after the virtual address intended, and
the type of request, which is identical to that of the request 50.

Referring now to the system described in FIG. 2, step 52 consists in determining the logic space and the virtual address or addresses on this space designated by the request 50, and in producing one or more “virtual” requests.

There is a difference in level between the file access requests and the virtual access requests. In fact, a file access request will target the contents of a substantial quantity of virtual addresses in order to be able to reconstitute the contents of a file, whereas a virtual request targets the contents of a block of data associated with this address.

The virtual access request or requests obtained are then sent to the virtualisation layer, which determines the physical address or addresses and the corresponding storage spaces in a step 54.

To determine the physical addresses, the virtualisation layer operates by using the motor 40 and the correspondence table 42.

Within the scope of a read access request, the desired file already exists in a storage space 38, and the motor 40 calls up the correspondence table 42 with the virtual address or addresses in order to determine by correspondence the physical address or addresses of the data in the file.

Within the scope of a write access request, the file does not necessarily exist beforehand in a storage space 38. Nevertheless, as has been seen previously, the correspondences between virtual addresses and physical addresses are fixed and the motor 40 then operates in the same way as within the scope of a read request to determine the physical address or addresses of the data.

In every case, once the motor 40 has determined the physical addresses, it generates physical access requests, in a step 56, which it sends to the storage client 44.

In the step 56, the physical access requests are generated on the basis of the request 50 and the physical address or addresses determined in step 54.

These requests comprise:
the physical address targeted;
the size of the request, i.e. the number of bits to access following the physical address targeted by the request; and
the type of action intended, namely read or write.

The physical address and the size of the request are obtained directly from step 54, and the type of request is inherited from the type of virtual access request in question.

A loop is then launched, in which a stop condition 58 is reached when a physical access request has been sent to the storage client 44 for all the physical addresses obtained in step 52.

In fact, each physical access request is placed in a request queue of the storage client 44 for execution in a step 60. The storage client 44 may optionally comprise a number of queues, for example a queue for each storage server 46 with which it interacts.

In this loop, all the physical access requests of step 56 are shown as being executed successively, for reasons of simplicity. However, execution may also be carried out in parallel and not only in series.

In the example described, requests are sent from layer to layer until they reach the physical access layer. However, it would be possible to determine and send only addresses (virtual and then physical) and to recover, at the level of the physical layer, the selected properties of the initial file request to form the physical access requests.

For executing a given physical access request, the storage client 44 interacts with the storage server 46 of the storage station which contains the storage space 38 on which is located the physical address designated by the physical access request in question. This interaction will be explained by means of FIG. 5.

As can be seen from FIG. 5, the execution of a physical access request by a storage client 44 comprises first of all the receiving of the physical access request by the storage server 46 in question. This receiving here takes the form of the sending of a header 62 which tells the storage server 46 the type of request, the size of this request and the physical address which are targeted.

The request, via its header, is then stored in a queue 64 in the storage server 46. The queue 64 contains all the access requests which have not yet been executed, sent by all the storage clients 44 to the storage server 46 in question, as well as their execution status.

A storage server 46 may comprise a number of queues 64, for example one queue for each storage client 44 in the network, or one queue for each storage space to which the storage server 46 manages access, or any other arrangement that is appropriate for implementing the scheduling strategies which will be described hereinafter.

The storage server 46 may thus receive, in a cascade, a substantial quantity of requests from one or more storage clients and can execute them in the order which is most favourable for occupying the station on which it is executed, the level of fullness of the disks which it manages, and the level of fullness of the network in general.

In known arrangements, the relationship between storage client and storage server is termed “client orientated”. In this type of relationship the queue of requests from the storage client 44 prevails, and the client is only permitted to send a new access request to a server when the latter has responded to the previous request.

The architecture described here constitutes a “server orientation” of the management of access to the storage space. In contrast to known arrangements, a given storage client 44 can thus send a multitude of access requests to the same storage server 46 without the latter having to first of all send back the results of a request sent previously by the storage client 44. This makes it possible to achieve a better balance of the disk and network loading in the input/output accesses and is particularly advantageous.

Parallel to receiving requests in its queue 64, the storage server 46 carries out a step 66 in a loop in which it schedules and executes the requests received in the queue. The request corresponding to the header 62 is therefore processed in this loop, in the order determined by the storage server.

In the step 66, the server executes a scheduling of the requests in the queue 64, in order to optimise locally the utilisation of storage spaces for which it manages access and the utilisation of the station on which it is executed, taking account of the parameters such as the processor load, the level of fullness of the central memory of the station, etc.

The scheduling and execution carried out in step 66 are explained by means of FIG. 6.

At a given moment, the storage server 46 has, in its queue, a set of requests which may be in various states. These states may be for example “to be processed” (when a request has just been received in the queue), “awaiting execution” (when the storage server 46 has all the data needed to execute a request and has programmed its execution for a later time), or “in the course of being executed”.

It also appears that these requests are of at least two separate kinds. A first kind is termed “network” and denotes an exchange which has to take place between the storage server 46 and a given storage client 44. The other kind is termed “disk” and denotes access which the storage server 46 has to carry out on one of the storage spaces that it manages, for reading or writing data.

The scheduling of the step 66 is carried out on the basis of the nature of these requests and their state, state parameters of the network of the system and state parameters of the storage spaces managed by the storage server 46, as well as the use of the station on which it is executed, taking account of parameters such as the processing load, the level of fullness of the central memory of the station, etc.

The step 66 will be described in relation to a case where the storage server manages a plurality of data storage disks. As a result, numerous elements which are of a global nature in relation to the loop are tables, possibly multi-dimensional.

Thus, a table will be used known as Last_Sect, which comprises a single line, and each column of which denotes the last sector accessed for the disk corresponding to this column.

Similarly, a matrix Tm_Used will be used, in which the lines each denote a storage client and the columns each denote a disk, the values of the elements at the intersection of the line x and column y representing the time of occupation of the disk y for requests emitted by the client x.

The loop of the step 66 processes data 70. The data 70 contains a list of requests File and a list of requests List_Req. The list of requests File contains a set of requests having a state “to be processed”, i.e. the requests received at that moment in the queue or queues of the storage server.

The list known as List_Req contains a set of requests with the status “awaiting execution” or “in the process of being executed”. These requests are each accompanied by an age indicator. The age indicator of a request indicates the number of loops which have been gone through since this request was added to the list List_Req.

In a step 72, the storage server calls up a function Init( ) with, as argument, the lists File and List_Req. The function Init( ) is described in more detail with reference to FIG. 7.

The function Init( ) starts in a step 700, with, in a step 702, the calling up of a function Add_New Req( ) which has, as arguments, the lists File and List_Req. The function Add_New_Req( ) has the role of taking all the new requests from the list File and adding them to the list List_Req. In the list List_Req, the age indicator of the new request is reset to 0 by the function Add_New_Req( ).

Step 702 is followed by a double condition relating to the occupation of the storage server, in order to optimise the functioning of the system. The first condition is tested in a step 704, in which a wait indicator Stat_Wt is tested.

When the indicator Stat_Wt is equal to 0, this means that there has not been any wait since the previous loop. Conversely, a wait during the previous loop is indicated by an indicator Stat_Wt equal to 1.

The second condition is tested in a step 706, in which the storage server verifies that there are more than two requests in the list File.

If one of these conditions is not met, i.e. if there has been a wait during the previous loop, or if there are more than two requests in the list File, the function Init( ) is carried out in a step 708 in which the indicator Stat_Wt is set at 0 for the next loop.

Then, in a step 710, the storage server checks whether the list List_Req is empty. If it is not, the function Init( ) terminates at step 712, and the scheduling loop can continue in order to process the requests in the list List_Req.

If the list List_Req is empty, then there is no need to continue the scheduling loop, and the storage server waits one millisecond by a function Wait(1) in a step 714, then sets the indicator Stat_Wt to 1 for the next loop and returns to step 702, to recover any new requests received by the queue or queues of the storage server.

After the function Init( ) the storage server calls up a function Run_Old( ) in a step 76. The aim of this function is to execute the requests of List_Req which have a very high age indicator.

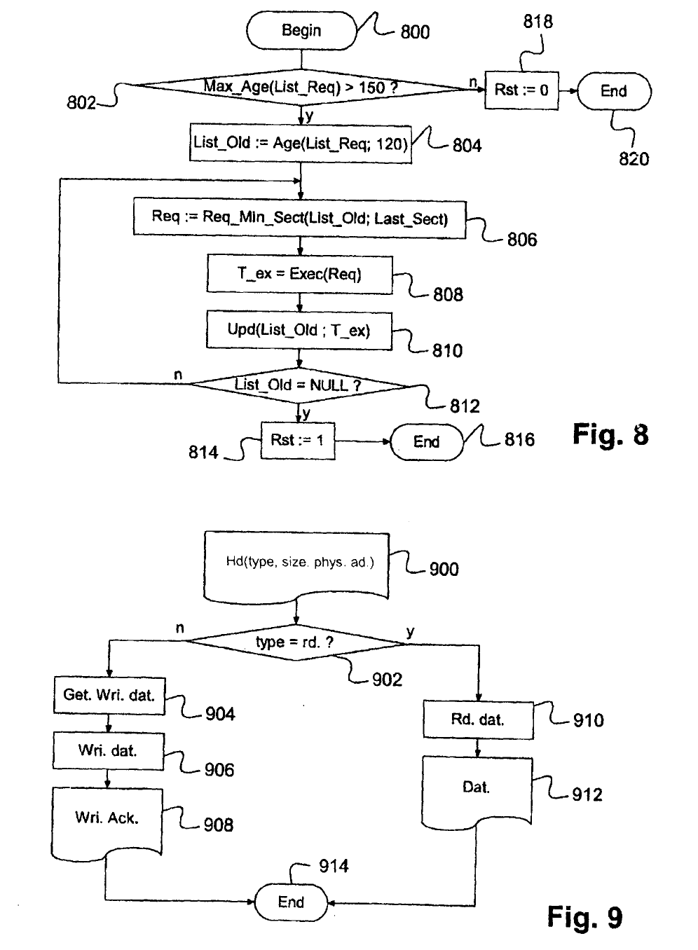

The function Run_Old( ) is described by means of FIG. 8, and returns an indicator Rst equal to 1 if an old request is executed, and equal to 0 if not.

After a starting step 800, the storage server calls up, in a step 802, a function Max_Age( ). The function Max_Age( ) takes, as argument, the list List_Req and returns the highest age indicator from the request in List_Req.

If this age indicator is greater than 150, then in a step 804 the storage server calls up a function Age( ) which takes as arguments the list List_Req and the number 120. The function Age( ) determines the set of requests in List_Req which have an age indicator greater than 120. These requests are stored in a request list List_Old.

Then, in a step 806, the storage server calls up a function Req_Min_Sect( ) with the list List_Old and the table Last_Sect as arguments. The function Reg_Min_Sect( ) makes it possible to determine which is the request among the list List_Old which has the request access sector closest to the last sector accessed recently.

This is done by calculating, for each request contained in List_Old, the absolute value of the distance between the disk sector targeted and the last sector accessed on this disk, as contained in Last-Sect. Once the minimum has been determined, the corresponding request is stored in a request Req.

Then the storage server executes the request Req by calling it up as argument of a function Exec( ) in a step 808. The function Exec( ) executes the request Req, measures the execution time of the request and stores this time in a number T_ex.

The execution of the request is described by means of FIG. 9. This execution is based on a triplet comprising the physical address-size-type of request 900 contained in the header in the queue 64.

In a step 902, a test as to the type of request determines the chain of disk and network inputs/outputs to be carried out.

If it is a write request, the storage server asks the storage client to send it the write data in a step 904. The storage server waits for the data and, on receiving them, enters them in the space designated by the physical address in a step 906.

The storage server 46 then sends a write receipt 908 to the storage client 44 to confirm the writing. After this, execution is completed in a step 914.

If it is a read request, the storage server 46 accesses the data contained in the space designated by the physical address in a step 910, up to the size of the request, and sends these data to the storage client 44 in a step 912. After this, execution is completed in a step 914.

Once the request Req has been executed, the storage server updates the List_Req in a step 810. This updating is carried out by calling up a function Upd( ) with as argument the list List_Req and the number T_ex.

This function withdraws the request Req from the lists List_Req and List_Old and updates a matrix Tm_Used, adding the number T_ex to the element at the intersection of the line which corresponds to the storage client 44 that has sent the request Req and the column which corresponds to the disk targeted by the request Req. This makes it possible to keep the occupation of each disk by each storage client up to date. Finally, the table Last_Sect is updated in the column of the disk which has been accessed by the request Req, to take account of the last sector actually accessed.

The storage server 46 then checks, in a step 812, whether the list List_Old is empty. If it is, then the indicator Rst is set to 1 in a step 814 to indicate that an “old” request has been executed and the function Run_Old( ) is completed in a step 816. If this is not the case the function Run_Old( ) returns to step 806 to execute the remaining other old requests.

If the function Max_Age( ) returns an age indicator less than 150, then the indicator Rst is set to 0 in a step 818 to indicate that no “old” request has been executed, and the function Run_Old( ) is completed in a step 820.

The scheduling and execution loop then continues with a test on the indicator Rst in a step 78, to determine whether an “old” request has been executed. If it has, then the storage server reiterates the loop with the step 72 by calling up the function Init( ) again.

If not, the storage server terminates the scheduling and execution loop by calling up a function Run_Min_Use( ) with as argument the list List_Req.

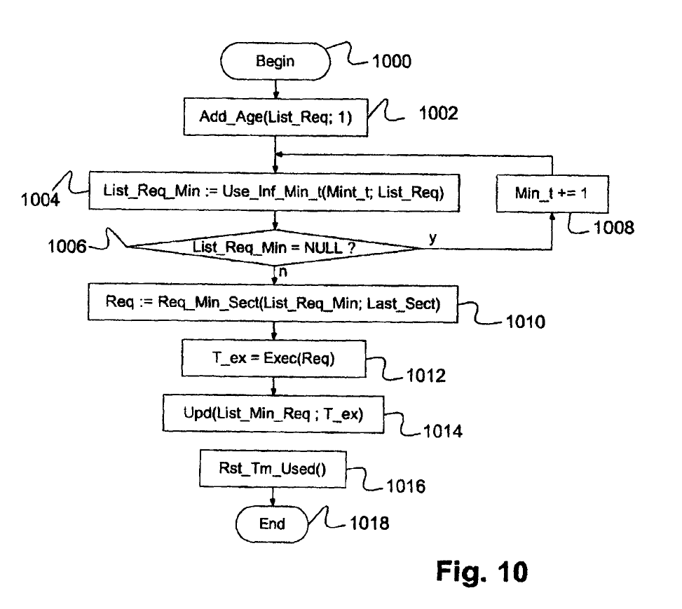

The function Run_Min_Use( ) is described with reference to FIG. 10. After initialisation in a step 1000, the storage server 46 calls up a function Add_Age( ) with as argument the number 1 in a step 1002. The function Add_Age( ) increments by 1 the age indicator of all the requests in the list List_Req and resets a counter Min_t to 0.

In a step 1004, the storage server 46 then calls up a function Use_Inf_Min_t( ) with as argument the list List_Req and the counter Min_t. The function Use_Inf_Min_t( ) runs through the list List_Req and verifies for each request whether the element of the matrix Tm_Used at the intersection of the line corresponding to the storage client 44 which has sent it and the column corresponding to the disk which it designates is less than Min_t.

Specifically, this means that a given request is selected if the client that has sent it has already occupied the disk that it targets for a time less than Min_t. All the requests thus selected are stored in a list List_Min_Req.

In a step 1006, the storage server tests to see whether List_Min_Req is empty. If it is, the counter Min_t is then incremented by 1 in a step 1008, and step 1004 is repeated.

Once the list List_Min_Req contains at least one request the storage server 46 executes steps 1010, 1012 and 1014 which differ from the steps 906, 908 and 910 described previously only in that it is the list List_Min_Req that is used here, instead of the list List_Old.

After the execution of the most favourable request according to steps 1010, 1012 and 1014, the storage server 46 calls up a function Rst-Tm-Used( ) in a step 1016.

The purpose of the function Rst-Tm-Used( ) is to reset the matrix Tm_Used in the event that one storage client 44 has made considerable use of the disks compared with the other storage clients.

For this, the function Rst-Tm-Used( ) adds up all the elements of the matrix Tm_Used. This represents the sum total of the occupancy times of the disks managed by the storage server 46 by all the storage clients 44.

If this sum total exceeds a predetermined value, then all the elements of the matrix Tm_Used are set to 0. If not, the matrix Tm_Used is unchanged.

After step 1016, the function Run_Min_Use( ) terminates in a step 1018, and the scheduling and execution loop starts again at step 72.

The function Run_Min_Use( ) thus makes it possible to schedule the execution of the request on the basis of information contained in the headers of the requests, regardless of the presence of any data designated by these requests.

It is therefore possible in this way to schedule the execution of a considerable quantity of requests, notably write requests, without overloading the memory space with the data to be written in these requests.

In other applications it would however be possible to schedule only the requests in the list File for which all the data needed for executing the request are available. This could be done by providing, in parallel, a data supply loop, thus ensuring that the space allocated to the storage of the request data is filled in such a way as to optimise the quantity of requests to be scheduled.

The step 66 has been described in relation to cases where the storage server manages a plurality of data storage disks.

As a result, numerous elements which are global by nature compared with the loop have been tables, sometimes multidimensional. If the storage server manages only a single disk, the situation may be simplified. Then, the element Last_Sect becomes a simple value, and the element Tm_Used becomes a one-dimensional table (the storage clients).

Moreover, the scheduling has been carried out here by placing all the requests in the queues of the storage server together. However, it would be possible to distinguish between the requests as a function of the queue from which they have been taken, respectively, either by indexing the list List_Req, or by executing a scheduling for each queue, in series or in parallel.

FIG. 11 shows an alternative embodiment of a scheduling and execution loop.

In this particular embodiment, the scheduling and execution loop is essentially identical to that shown in FIG. 6, except that it also has a sleep loop 110 which is executed prior to the steps shown in FIG. 6.

The sleep loop 110 comprises a sleep management function Sleep_Mng( ) 112 the result of which is stored in a variable Slp.

The variable Slp indicates the decision to put the storage server to sleep temporarily or not. This function will be described further on in connection with FIGS. 13 to 15.

After the function Sleep_Mng( ) 112, the sleep loop 110 comprises a test 114 relating to the value of the variable Slp.

If this variable is not zero, then the storage server is temporarily put to sleep by a function Force_Slp( ) 116. Then the sleep loop 110 is reset at 112.

The function Force_Slp( ) 116 “puts the storage server to sleep” by sending a request known as “put to sleep” in the queue. The put to sleep request takes priority over all the other requests. When it is executed, it causes the storage server to run empty for a parametrable time. This function can be viewed as the equivalent of the function Wait( ) in FIG. 7.

If the variable Slp is zero, the scheduling and execution loop is executed exactly as shown in FIG. 6.

The function Slp_Mng( ) will now be described with reference to FIG. 12. As can be seen from this Figure, the function Slp_Mng( ) comprises the sequential execution of a function Upd_Slp_Par( ) 1122, a function Perf_Slp( ) 1124, and a function Mnt_Slp( ) 1126, before terminating at 1128.

The role of the function Upd_Slp_Par( ) 1122 is to update the parameters used to decide whether or not to put the server to sleep. This function will now be described with the aid of FIG. 13.

As can be seen from FIG. 13, the function Upd_Slp_Par( ) 1122 updates two parameters Tm_psd, Nb_Rq_Slp and the variable Slp.

In a step 1302, the parameter Tm_psd is updated with a function Elps_Time( ). The function Elps_Time( ) calculates how much time has elapsed since the last execution of the function Upd_Slp_Par( ) 1122.

This can be done, for example, by retaining, from one loop to the next, a time/date variable which is updated on each execution, and by comparing this variable with the current time on execution during the following loop.

In a step 1304, the parameter Nb_Rq_Slp is incremented by a value Tm_psd*Fq_Rq_Slp. The parameter Nb_Rq_Slp represents a number of requests to put to sleep.

In the embodiment described here, there are two principal types of sleep conditions. The first is a type of condition connected to performance. The second is a type relating to a nominal occupation level. This level may be defined in particular by means of the administration module or in general terms may be seen as a parameter fixed by the system administrator.

The parameter Nb_Rq_Slp belongs to this second type. It is a counter which ensures that the server creates sleep requests with a frequency Fq_Rq_Slp which is a parameter regulated by the administrator of the storage server.

However, as will become apparent further on, the sleep requests are only actually executed under certain conditions. This counter makes it possible to determine how many sleep requests could have been executed.

Then, in a step 1306, the variable Slp is reset to 0 for the current sleep loop, and the function Upd_Par_Slp( ) terminates at 1308.

The function Perf_Slp( ) will now be described with reference to FIG. 14. This function makes it possible to decide on putting to sleep on the basis of the state parameters of the storing node and the queue.

For this, this function is based on two tests 1402 and 1404. The first test 1402 relates to the level of occupation of the local resources, i.e. the resources of the storing node on which the storage server is executed.

In the embodiment described here, it is the processor resources that are tested. To do this, functions of evaluating the occupancy level of the processor are called up. These functions may be of a standard type and may be based for example on consulting global variables maintained by the operating system, or they may be more specific functions.

If the processor is already under extreme load (above 90%, for example), it is then decided to put the storage server to sleep so that it does not impair the performance of the storing node.

Thus, if this is the case, the variable Slp is set to 1 at 1406 and the function Perf_Slp( ) terminates at 1408.

It will be noted that numerous other conditions may be used here in conjunction with the processor load, or instead of it, such as the access load of the local memory unit, for example, or others which the skilled man will be able to envisage.

The second test 1404 is only carried out if the first test 1402 is negative, i.e. if the processor load is not too great. This second test relates to the evaluation of the number of requests contained in the queue.

In fact, if this number is too low, the storage server is not making good use of the scheduling loop, thus potentially reducing performance.

Consequently, if the number of requests present in the queue is too low, the variable Slp is set at 1 at 1406, and the function Perf_Slp( ) terminates at 1408. Otherwise, the function terminates directly at 1408.

It will be noted that here, too, numerous other conditions may be used, the principle being to put the storage server to sleep as long as favourable performance conditions have not been met.

Among these alternative conditions one may note for example the type of requests present in the queue. Thus, if the requests are “distant”, i.e. if the distance between the physical address designated by each request and a physical address accessed previously by the storage server is above a fixed threshold, it may be considered to be more favourable to wait for a “closer” request to arrive in the queue. Another criterion of type which may be used is the nature of the request, i.e. read or write, or other criteria relating to the characteristics of the requests.

The function Mnt_Slp( ) will now be described with the help of FIG. 15. This function makes it possible to cancel a planned period of sleep, or on the contrary, to impose a “maintenance” sleep. The function Mnt_Slp( ) is based on two tests 1502 and 1508.

The first test 1502 compares the parameter Nb_Rq_Slp with a minimum number of sleep requests which are needed in order to allow one of them to be executed. This comes down to determining whether a number of sleep requests have been executed recently.

If the parameter Nb_Rq_Slp is less than the minimum number, the variable Slp is set to 0 at 1504 and the function terminates at 1506.

The second test 1508 is only carried out if the first test 1502 is positive. This second test compares the parameter Nb_Rq_Slp with a maximum number of sleep requests. This comes down to determining whether it is a very long time since any sleep request has been executed.

If the parameter Nb_Rq_Slp is less than the maximum number, the function terminates at 1506. In the opposite case, the variable Slp is set to 1 at 1510, then the function terminates at 1506.

This means that:
even if it is planned a priori to execute a sleep request, this will not be done because many other requests have already been executed a short time ago, or on the contrary,
when a certain length of time has elapsed and no sleep request has been executed, an arbitrary decision is made to execute one, even if it is not necessary in the light of the other criteria.

Owing to the fact that the function Mnt_Slp( ) is executed after the function Perf_Slp( ) it will be understood that it can overturn the decisions of the latter. In other words, for reasons of maintenance of the storage server, this function makes it possible to cancel a planned sleep period or to force one which had not been planned by acting on the variable Slp.

It will also be noted that the function Force_Slp( ) decreases the counter Nb_Rq_Slp by one unit on each execution.

As will become apparent from reading the foregoing, the scheduling and execution loop comprises three main parts processed in series and an optional pre-loop:
an optional sleep loop for guaranteeing the performance of the storing mode on which the storage server is located;
a first part for managing new requests;
a second part for processing the oldest requests;
a third part for processing requests coming from the storage clients that have least used the storage server.

It is clearly apparent that these parts are independent of one another and that a simplified loop might contain only one or several of the latter. It is also equally clear that the processing of these parts could be parallel and that instead of resetting the loop after executing the “old” requests, it would be possible to carry out the third part.

The second and third parts may be seen as being particular examples of more general concepts.

Thus, in the second part, the processing of the “old” requests arises from a need to manage the “exceptional” requests, which for whatever reason have not been executed as a priority by the algorithm. This is the guiding concept which must be remembered, in that other implementations for avoiding such cases could be envisaged.

As for the third part, the general concept is to schedule the requests as a function of a quantitative criterion based on the relationship between the storage client and the storage server. Thus, in the example described, a quantitative criterion of usage time of local memory units is used to discriminate between the requests.

However, it would be possible to use other quantitative criteria based on statistics which characterise the storage client/storage server interactions, such as the average level of data exchange, the mean network latency found during these interactions, the level of loss of packets, etc.

Moreover, the implementation described here is given as a simplified example and could be further improved by the use of conventional programming techniques, such as the use of buffers, or taking account of other parameters for the scheduling.

In the description provided, scheduling is based on a strategy that favours two principal axes: the execution of old requests and the sharing of the load between the disks and the clients.

Other strategies may be implemented (by correspondingly changing the foregoing) to favour other approaches such as:
maximising the exploitation of the disk bandwidth, for example by aggregating the requests which are adjacent or nearly adjacent into a single request, thus saving on disk access;
maximising the exploitation of the disk latency, for example by generating, at the storage server, optimisation requests targeting the centre of the disk or disks in order to reduce latency, or by generating predictive requests (i.e. targeting data by anticipating a future request) at the storage server.

Other strategies and their implementation as well as numerous variants will be obvious to the skilled man.

Thus, the application which accesses the stored data may comprise a driver which manages the relationships between the various elements such as the interaction between application and file system, the interaction between file system and correspondence module, the interaction between correspondence module and storage client, implementation of the strategy of the storage server by obtaining a result from each element and by calling up the next element with this result (or a modified form of this result).

Alternatively, the system may be autonomous and not depend on the application which calls up the data, and the elements may be capable of communicating with one another, such that the information travels down the layers and then up again from element to element.

Similarly, the communications between these elements may be ensured in different ways, for example by means of the POSIX interface, the IP, TCP and UDP protocols, a shared memory, an RDMA (Remote Direct Access Memory). It should be borne in mind that the aim of the invention is to provide the advantages of specialised storage systems on the basis of existing network resources.

An embodiment of the system described above is based on a network in which the stations are produced with computers comprising:
a specialised or general processor (for example of the CISC or RISC type or other),
one or more storage disks (for example hard disks with a serial ATA or SCSI interface or other) or any other type of storage, and
a network interface (for example Gigabit, Ethernet, Infiniband, SCI . . . )
an application environment based on an operating system (such as Linux) for supporting applications and providing a file system manager,
an application assembly for producing the correspondence module, for example the Clustered Logical Volume Manager module of the application Exanodes (registered trade mark) of the company Seanodes (registered trade mark),
an application assembly for producing the storage client and the server client of each NBD, for example the Exanodes Network Block device module of the application Exanodes (registered trade mark) of the company Seanodes (registered trade mark),
an application assembly for managing the shared elements, for example the Exanodes Clustered Service Manager module of the application Exanodes (registered trade mark) of the company Seanodes (registered trade mark).

This type of system may be produced in a network comprising:
conventional user stations adapted to application use on a network and acting as application nodes, and
a set of computer-based equipment produced in accordance with the foregoing description, acting as servers of the network and storage nodes.

Other equipment and applications will become apparent to the skilled man for producing alternative embodiments of the apparatus within the scope of the invention.

The invention encompasses the computer-based system comprising the application nodes and the storing nodes as a whole. It also encompasses the individual elements of this computer-based system and especially the application nodes and the storing nodes taken separately, as well as the various means for producing them.

Similarly, the data management process should be considered in its entirety, i.e. in the interaction of the application nodes and storing nodes, but also with regard to the individual computer-based facilities adapted to produce the application nodes and the storing nodes of this process.

The foregoing description sets out to describe a particular embodiment of the invention. It should not be considered as restrictive or describing the latter in a restrictive manner and covers in particular all the combinations of the features of the variants described with one another.

As products the invention also covers the software elements described which are made available in any computer-readable “medium” (support). The expression “computer-readable medium” encompasses magnetic, optical and/or electronic data storage supports, as well as a transmission support or vehicle, such as an analogue or digital signal.

Such media also include the software elements themselves, namely the elements adapted to be run directly, such as the software elements used for installation and/or deployment, such as an installation disk or remotely loadable installation program. Such an installation may be carried out globally, over client stations and server stations, or separately, with appropriate products each time.

1-34. (canceled)

35. A computer-based system comprising:
a plurality of computer-based facilities termed nodes interconnected in a network;
at least some of the nodes, as storing nodes, comprising at least one local direct-access memory unit, and a storage server arranged to manage access to this local memory unit on the basis of a queue of access requests;
at least some of the nodes, as application nodes, each comprising:
an application environment having a representation of files that are accessible from this respective node in a form of block addresses, each designating at least one physical address on a local memory unit of a storing node, and
a storage client capable of interacting with any one of the storage servers, on the basis of an access request designating a block address, wherein at least one of the storage servers comprises a scheduler capable of executing the access requests contained in its queue in a specified order, and wherein the scheduler is arranged to determine this order as a function of a set of rules forming performance criteria, and involving one or more state parameters of the queue and/or of the storing node on which it resides.

36. A computer-based system according to claim 35, wherein the set of rules also involves one or more state parameters of the local memory unit.

37. A computer-based system according to claim 35, wherein the set of rules comprises a rule appropriate to a selection of requests present in the queue and based on content of a header of each request, and wherein this rule is operational in the absence of other data associated with these requests.

38. A computer-based system according to claim 35, wherein the set of rules comprises a rule appropriate to a selection of requests present in the queue and based on a quantitative criterion established on the basis of previous interactions of this storage client with the storage server in question.

39. A computer-based system according to claim 38, wherein the quantitative criterion is established on the basis of a duration of prior loading of the storage server in question by the storage client.

40. A computer-based system according to claim 35, wherein the set of rules comprises a rule appropriate to a selection of requests present in the queue and based on a length of time the requests have been present in the queue.

41. A computer-based system according to claim 35, wherein the set of rules comprises a rule appropriate to a selection of requests present in the queue and based on a distance between a physical address designated by each request and a physical address accessed previously by the storage server.

42. A computer-based system according to claim 35, wherein at least one of the storage servers is arranged so as to execute the access requests contained in its queue in an order which is determined as a function of a set of rules selected from among a plurality of different sets of rules forming strategies with regard to the performance criteria.

43. A computer-based system according to claim 35, wherein at least some of the storage clients are authorized to selectively send an access request to a given storage server, before completion of an access request to this storage server, sent previously by the storage client in question.

44. A computer-based system according to claim 35, wherein at least some of the storage servers manage plural local memory units.

45. A computer-based system according to claim 35, wherein at least some of the nodes are application nodes and storing nodes.

46. A computer-based system according to claim 35, wherein the set of rules comprises a rule appropriate to shifting execution of the requests contained in the queue for a selected length of time.

47. A computer-based system according to claim 46, wherein the rule is based on a level of occupation of the resources of storing node.

48. A computer-based system according to claim 46, wherein the rule is based on a criterion selected from a number of requests contained in the queue, or a type of requests contained in the queue.

49. A computer-based system according to claim 46, wherein the rule is based on evaluating a time that has elapsed since a previous shift.

50. A computer-based system according to claim 35, further comprising a correspondence module capable of maintaining a correspondence between each block address and at least one physical address on a local memory unit of a storing node.

51. A computer-based system according to claim 50, wherein the correspondence module comprises a correspondence table comprising a correspondence between each block address and at least one physical address on a local memory unit of a storing node, and a motor configured to define at least one physical address for a given request by interrogating the correspondence table with a block address, and sending the given request with the physical address or addresses determined to the storage client in question for execution of the given request.

52. A process for data management which can be used in a network comprising a plurality of interconnected computer-based facilities, as nodes, comprising:
a) sending a file request from an application node of the network, on the basis of a representation in a form of virtual addresses;
b) on the basis of a correspondence between each virtual address and at least one physical address on a local memory unit of a storing node of the network, determining at least one physical address corresponding to the virtual address;
c) sending an access request designating the physical address from a storage client to a storage server managing access to the local memory unit associated with the physical address; and
d) placing the access request in a queue in the storage server and executing the access requests contained in the queue, in an order which is determined as a function of a set of rules forming performance criteria, and involving one or more state parameters of the queue and/or of the storing node on which it resides.

53. A process according to claim 52, wherein the set of rules also involves one or more state parameters of the local memory unit.

54. A process according to claim 52, wherein the set of rules comprises a rule appropriate to a selection of requests present in the queue and based on the content of a header of each request, and the rule comes into effect in the absence of other data associated with these requests.

55. A process according to claim 52, wherein the set of rules comprises a rule appropriate to a selection of requests present in the queue and based on a quantitative criterion established on the basis of previous interactions of the storage client issuing each request with the storage server in question.

56. A process according to claim 55, wherein the quantitative criterion is established on the basis of a duration of prior loading of the storage server in question by the storage client.

57. A process according to claim 52, wherein the set of rules comprises a rule appropriate to a selection of requests present in the queue for a selected length of time.

58. A process according to claim 52, wherein the set of rules comprises a rule appropriate to a selection of requests present in the queue and based on a distance between the physical address designated by each request and a physical address accessed previously by the storage server.

59. A process according to claim 52, wherein the set of rules comprises a plurality of rules selected from among a plurality of different sets of rules forming strategies with regard to the performance criteria.

60. A process according to claim 52, wherein the c) sending can be reproduced by the same access request sender with another physical address, before the completion of the d) placing for an access request to this storage server, sent beforehand by the access request sender in question.

61. A process according to claim 52, wherein at least some of the storage servers comprise a queue for each access request sender.

62. A process according to claim 52, wherein at least some of the storage servers manage access to a plurality of local memory units.

63. A process according to claim 52, wherein the set of rules comprises a rule appropriate to shifting execution of the requests contained in the queue for a selected length of time.

64. A process according to claim 63, wherein the rule is based on a level of occupation of the resources of the storing node.

65. A process according to claim 63, wherein the rule is based on a criterion selected from among a number of requests contained in the queue, or a type of requests contained in the queue.

66. A process according to claim 63, wherein the rule is based on evaluating a time that has elapsed since a previous shift.

67. A computer-based device forming a storing node arranged to carry out the d) placing of the process according to claim 52.

68. A computer program product comprising program coding means adapted to carry out the process according to claim 52 when run on a computer.
